(19) United States
(12) Patent Application Publication
(10) Pub. No.: US 2009/0121679 A1
(43) Pub. Date: May 14, 2009

(54) APPARATUS FOR SUPPLYING POWER TO A PORTABLE ELECTRONIC DEVICE

(75) Inventors: Matthew D. Thomas, Atlanta, GA (US); Grant H. Lloyd, Lawrenceville, GA (US); David P. Townsend, Village Of Lakewood, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/938,680

(22) Filed: Nov. 12, 2007

(51) Int. Cl. H02J 7/00

(52) U.S. Cl. 320/114; 320/107; 320/137

(57) ABSTRACT

Disclosed is an apparatus for supplying power to a portable electronic device. The apparatus comprises a power adapter, a replaceable lens, and a detachable module. The power adapter is coupled to a power source and is capable of receiving power from the power source. The replaceable lens is removably secured to the power adapter. Further, the detachable module is coupled to the power adapter and is capable of supporting the replaceable lens, when the replaceable lens is secured to the power adapter.

### FIELD OF THE DISCLOSURE

The present disclosure relates generally to a portable electronic device and more particularly to an apparatus for supplying power to a portable electronic device.

### BACKGROUND

In a portable electronic device powered by a rechargeable battery, such as a cellular telephone or any other electronic device, an external power source is usually required so that a user may recharge the battery coupled to the portable electronic device by using power from the external power source. In recent times, as the use of the cellular telephones is becoming prominent, the power adapters have been designed to recharge the battery, even while the user is traveling. For example, to recharge the battery of the portable electronic device inside a vehicle, power adapters are commonly designed to fit into a power source provided in the vehicle.

For power adapters, it is desirable to display on the power adapters, a symbol that may be a manufacturer's logo. The symbol may be designed to differentiate the manufacturer of the power adapter from its competitors. Some power adapters have a provision to display the symbol, for example, on a fixed plastic piece moulded on the power adapters. In some cases, a light source may be provided to illuminate the symbol on the power adapter. Various power adapter models have to be designed in order to display the symbol according to the need of the user. However, such power adapters may not be customized at the user end to redesign the symbol and/or replace a portion displaying the symbol from the power adapters. This may result in pricing the power adapter at a high cost.

Accordingly, there is a need for an improved apparatus for supplying power to a portable electronic device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a power adapter in accordance with some embodiments.

FIG. 2 is a cut-away view of the power adapter, through line 2-2′ of FIG. 1, which illustrates an example of internal circuitry of the power adapter.

FIG. 3 is an exploded view of a power adapter in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before describing in detail embodiments that are in accordance with the invention, it should be observed that the embodiments reside primarily in combinations of apparatus for supplying power to a portable electronic device. Accordingly, apparatus components have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. A device or structure that is “configured” in a certain way is configured in at least that way, but may also be configured in ways that are not listed.

Various embodiments of the invention provide an apparatus for supplying power to a portable electronic device. The apparatus comprises a power adapter, a replaceable lens, and a detachable module. The power adapter is coupled to a power source and is capable of receiving power from the power source. The replaceable lens is removably secured to the power adapter. Further, the detachable module is coupled to the power adapter and is capable of supporting the replaceable lens, when the replaceable lens is secured to the power adapter.

Generally speaking, a power adapter, such as a vehicle power adapter provides convenience to a user of a portable electronic device, to use the portable electronic device even while the user is traveling in a vehicle. This can be done by providing power to the portable electronic device from a power source built in the vehicle, when the battery of portable electronic device requires charging. Example of such portable electronic devices include but are not limited to mobile telephones, personal digital assistants, personal computers equipped for wireless operation, and a cellular handset or device. In one example, the power adapter may be a cigarette lighter adapter, which may be adapted to plug in to a cigarette lighter socket in the vehicle so as to receive power from the vehicle power source.

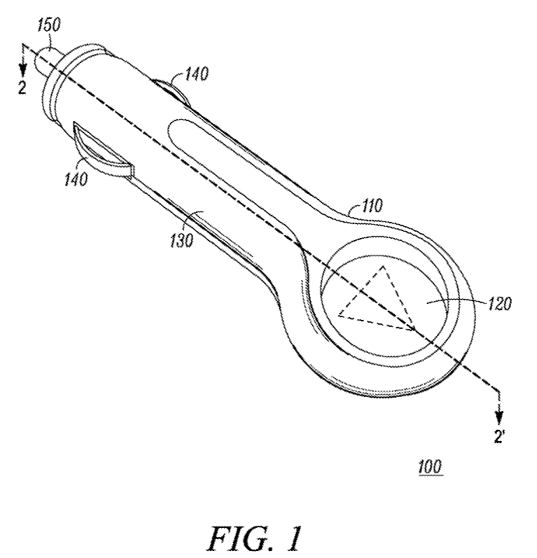

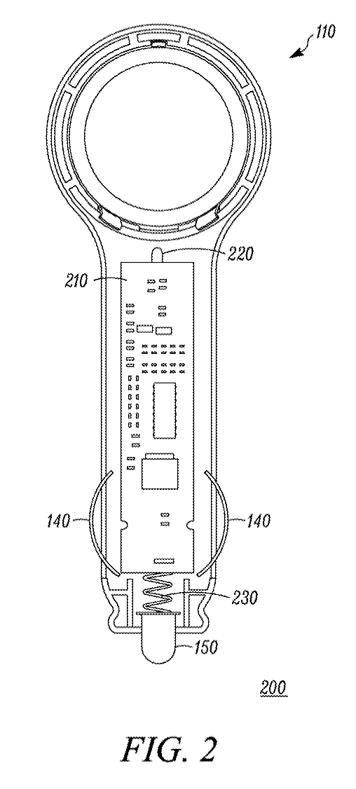

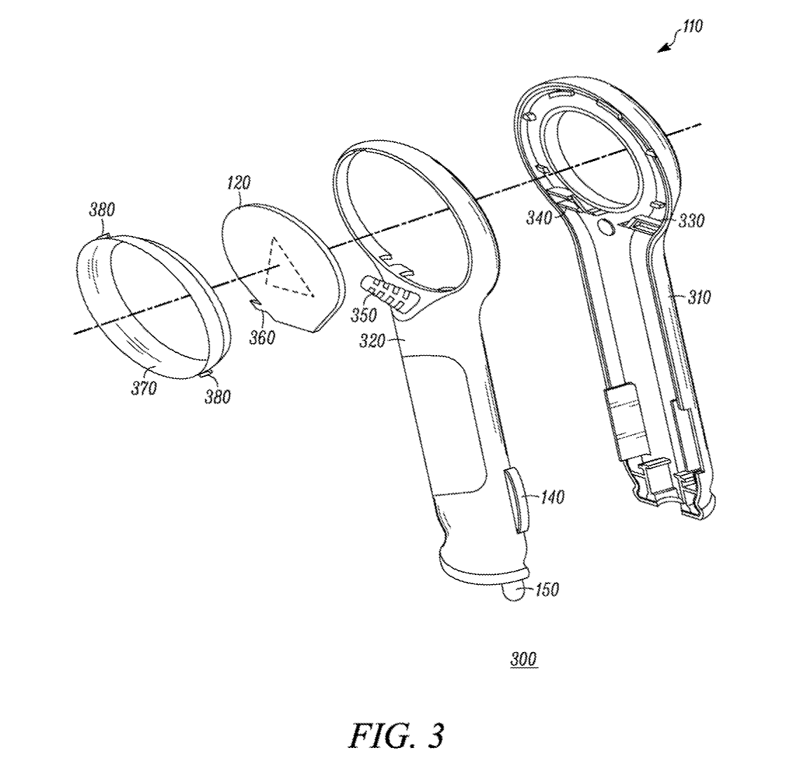

Referring now to the drawings and in particular to FIG. 1, there is shown a perspective view of a power adapter 110 in accordance with some embodiments. The power adapter 110 as shown comprises a replaceable lens 120 and an exterior housing 130. The power adapter 110 also includes a pair of electrical contacts 140 and a metallic cap 150. In the embodiments of the invention, the power adapter 110 may be coupled to a power source and is capable of receiving power from the power source. It will be apparent to a person with ordinary skill in the art that any type of power source may be supplied to the power adapter 110. In one example, the power adapter 110 may be powered via DC and in the range on 10.8 V-33V. Remaining parts of the power adapter 110 are illustrated and explained with reference to FIG. 2 and FIG. 3.

The replaceable lens 120 may be removably secured to the power adapter 110. The replaceable lens 120 may be designed to display a symbol at a center of the replaceable lens 120. In one example, the symbol may be a manufacturer's logo that may be designed on the replaceable lens 120 to differentiate the manufacturer of the power adapter 110 from its competitors. In one example, the replaceable lens 120 may be replaced by the user with another lens which has the user designed symbol. Alternatively, in another example the symbol may be designed by the user of the power adapter 110, and thereby provides the user customization to design the symbol on the replaceable lens 120.

Referring now to FIG. 2, there is shown a cut-away view 200 of the power adapter 110 which illustrates an internal circuitry of the power adapter 110, in accordance with some embodiments. The power adapter 110 as shown comprises the pair of electrical contacts 140, the metallic cap 150, an electronic circuitry 210, a light source 220, and a spring 230.

In one example, the electronic circuitry 210 modulates voltage or current to properly supply power to the portable electronic device. The light source 220 may be coupled to the electronic circuitry 210 and is capable of illuminating the replaceable lens 120 uniformly. Further, the pair of electrical contacts 140 and the spring 230 covered with a metallic cap 150 are coupled to the electronic circuitry 210, and may be capable of supplying voltage or current to the portable electronic device.

In one example, the light source 220 may be a light emitting diode (LED) and may be configured to illuminate the replaceable lens 120 uniformly with different colors. In one example, the replaceable lens 120 may be transparent or translucent and may comprise a texture that may help in illuminating the replaceable lens 120 uniformly when a light from the light source 220 falls on the replaceable lens 120.

Referring now to FIG. 3, there is shown an exploded view 300 of the power adapter 110, in accordance with some embodiments. The exploded view 300 shows an exterior housing 310, a lower exterior housing 320, a replaceable lens 120, and a detachable module 370. In one example, the upper exterior housing 310 and the lower exterior housing 320 molded together form the power adapter 110. The upper exterior housing 310 comprises a closed ended slot 330, an open ended slot 340. The lower exterior housing 320 comprises a power cord 350. The replaceable lens 120 comprises a projection 360 and the detachable module 370 comprises a locking mechanism 380. In the present embodiment, the power cord 350 may be coupled to the electronic circuitry 210. In this case, the electronic circuitry 210 may be attached to the lower exterior housing 320. Further, the power cord 350 electrically couples the power adapter 110 and the portable electronic device.

The upper exterior housing 310 and the lower exterior housing 320 may be moulded together to house the inner components, including the electronic circuitry 220, of the power adapter 110. In this case, the upper and the lower exterior housing 310, 320 of the present invention may be manufactured from a durable plastic. In one example, the durable plastic may be ABS, polycarbonate, or polycarbonate—ABS manufactured by way of an injection moulding process. The upper exterior housing 310 and the lower exterior housing 320 may be moulded together using the various moulding techniques known to a person with ordinary skill in the art. The upper exterior housing 310 includes the closed ended slot 330 and the open ended slot 340. In one example, when the replaceable lens 120 is secured to the power adapter 110, the projection 360 from the replaceable lens 120 that extends outward, fits into the open ended slot 340 and removably secures the replaceable lens 120 to the power adapter 110.

The replaceable lens 120 may be substantially circular having a flat edge at one end. The replaceable lens 120 may be of various other shapes, and all such embodiments are within the scope of the invention. In one example, the flat edge of the replaceable lens 120 may be adjacent to the light source 220, when the replaceable lens 120 is secured to the power adapter 110.

In the present embodiment of the invention, the detachable module 370 is coupled to the power adapter 110 and is capable of supporting the replaceable lens 120, when the replaceable lens 120 is removably secured to the power adapter 110. In one example, the locking mechanism 380 of the detachable module 370 may prevent the detachable module 370 to displace from its position when coupled to the power adapter 110.

Further, the detachable module 370 may secure the replaceable lens 120 and may be capable of separating from the power adapter 110, without detaching the upper exterior housing 310 and the lower exterior housing 320. The replaceable lens 20 may be replaced with a new lens, once the detachable module 370 is separated from the power adapter 110.

In an overview, the manufacturers of a vehicle power adapter may ship the vehicle power adapter, e.g. the power adapter 110, with a detachable module coupled to the vehicle power adapter and a replaceable lens separately so as to provide the user the option of customizing the replaceable lens according to his needs. In some cases, the manufacturers may require manufacturing the vehicle power adapter and the detachable module on standard basis, and manufacture the replaceable lens based upon the users provided requirements for the symbol designed on the replaceable lens.

We claim:

1. An apparatus for supplying power to a portable electronic device, comprising:
a vehicle power adapter coupled to a power source, the vehicle power adapter capable of receiving power from the power source;
a replaceable lens removably secured to the vehicle power adapter; and
a detachable module coupled to the vehicle power adapter, the detachable module capable of supporting the replaceable lens when the replaceable lens is secured to the vehicle power adapter.

2. The apparatus of claim 1 further comprises, a light source coupled to an electronic circuitry of the vehicle power adapter.

3. The apparatus of claim 2, wherein the light source is capable of illuminating the replaceable lens uniformly.

4. The apparatus of claim 1, wherein the replaceable lens comprises a projection to secure the replaceable lens to the vehicle power adapter.

5. The apparatus of claim 1, wherein the detachable module comprises a locking mechanism to prevent the detachable module from displacing from its position when coupled to the vehicle power adapter.

6. An apparatus for supplying power to a portable electronic device, comprising:
a power adapter coupled to a power source, the power adapter capable of receiving power from the power source;
a replaceable lens removably secured to the power adapter;
a light source coupled to an electronic circuitry of the power adapter, the light source capable of illuminating the replaceable lens; and
a detachable module coupled to the power adapter, the detachable module capable of supporting the replaceable lens when the replaceable lens is secured to the power adapter.

7. The apparatus of claim 6, wherein the replaceable lens is substantially circular having a flat edge at one end.

8. The apparatus of claim 7, wherein the flat edge is adjacent to the light source when the replaceable lens is coupled to the power adapter.

9. The apparatus of claim 6, wherein the replaceable lens comprises a projection to secure the replaceable lens to the power adapter.

10. The apparatus of claim 6, wherein the detachable module comprises a locking mechanism to prevent the detachable module from displacing from its position when coupled to the vehicle power adapter.

11. An apparatus for supplying power to a portable electronic device, comprising:
a vehicle power adapter coupled to a DC power source of a vehicle, the vehicle power adapter capable of receiving power from the DC power source of the vehicle;
a replaceable lens removably secured to the vehicle power adapter;
a light source coupled to an electronic circuitry of the vehicle power adapter, the light source capable of illuminating the replaceable lens; and
a detachable module coupled to the vehicle power adapter, the detachable module capable of supporting the replaceable lens when the replaceable lens is secured to the vehicle power adapter.

12. The apparatus of claim 11, wherein the replaceable lens is substantially circular having a flat edge at one end.

13. The apparatus of claim 12, wherein the flat edge is adjacent to the light source when the replaceable lens is coupled to the vehicle power adapter.

14. The apparatus of claim 11, wherein the light source illuminates the replaceable lens uniformly.

15. The apparatus of claim 11, wherein the replaceable lens comprises a projection to secure the replaceable lens to the vehicle power adapter.

16. The apparatus of claim 11, wherein the replaceable lens is customized to display a logo at a center of the replaceable lens.

17. The apparatus of claim 11, wherein the detachable module comprises a locking mechanism to prevent the detachable module from displacing from its position when coupled to the vehicle power adapter.
